(19) United States
(12) Patent Application Publication
(10) Pub. No.: US 2008/0176663 A1
(43) Pub. Date: Jul. 24, 2008

(54) STRUCTURE FOR MOUNTING DYNAMIC DAMPER ON ROTARY SHAFT AND ROTARY SHAFT EQUIPPED WITH DYNAMIC DAMPER

(75) Inventors: Keishi HATANAKA, Komaki-Shi (JP); Naohito Kuwayama, Nagoya-Shi (JP)

Correspondence Address: BURR & BROWN, PO BOX 7068, SYRACUSE, NY, 13261-7068, US

(73) Assignee: Tokai Rubber Industries, Ltd., Komaki-Shi (JP)

(21) Appl. No.: 11/953,943

(22) Filed: Dec. 11, 2007

(30) Foreign Application Priority Data
Jan. 22, 2007 (JP) 2007-011290

(51) Int. Cl. F16F 7/10

(52) U.S. Cl. 464/180

(57) ABSTRACT

A structure for mounting a dynamic damper on a rotary shaft is disclosed. The dynamic damper comprises a mass member having a center of gravity at a position deviated from the axial center thereof toward a first end of axially opposite ends, and a first and second elastic support members which elastically support the mass member and allow the mass member to be relatively displaced. The mass member is mounted on the rotary shaft by fixing the first and second elastic support members to the rotary shaft, such that an axial first section having the center of gravity of the mass member is located closer to the position of the loop of the bending vibration on the rotary shaft than an axial second section, whereby the dynamic damper is mounted on the rotary shaft.

The present application is based on Japanese Patent Application No. 2007-011290 filed on Jan. 22, 2007, the contents of which are incorporated herein by reference.

### BACKGROUND OF THE INVENTION

1. Field of the Invention

The present invention relates to a structure for mounting a dynamic damper on a rotary shaft and a rotary shaft equipped with a dynamic damper. More particularly, the invention relates to a structure for mounting a dynamic damper on a rotary shaft, in which the dynamic damper can advantageously be mounted at a portion axially apart from a position of a loop or an antinode of bending vibration on the rotary shaft where the bending vibration is occurred, and also relates to a rotary shaft equipped with a dynamic damper obtained by employing the mounting structure.

2. Description of Related Art

On rotary shafts such as a drive shaft and a propeller shaft of an automobile, to which bending vibration is applied, there is conventionally mounted a dynamic damper to damp the vibration. There have been proposed various types of such dynamic dampers. As one type of the dynamic dampers, there is known a dynamic damper formed by including a cylindrical mass member that can be mounted on a rotary shaft and axially extends with a predetermined thickness and two elastic support members that are fixed to axially opposite ends of the mass member with a predetermined distance therebetween to elastically support the mass member so as to allow the mass member to be displaced relatively to the rotary shaft upon the mass member being mounted on the rotary shaft (e.g. See, JP-A-09-89047 and JP-B-07-47978).

As is well known, the dynamic damper mounted on the rotary shaft can exhibit a maximum vibration damping effect when a natural vibration frequency of the damper coincides with a resonance frequency (natural vibration frequency) of the rotary shaft on which the damper is mounted. Basically, the natural vibration frequency of the dynamic damper is determined by a mass of the mass member and spring constants of the elastic support members supporting the mass member. It is also well known that the most appropriate position for mounting the dynamic damper on the rotary shaft is a position where the dynamic damper can be mounted in such a manner that the entire mass of the mass member is supported by a portion located at a position of loop of the bending vibration on the rotary shaft.

Thus, in the conventional dynamic damper having the structure as described above, in order to obtain a vibration damping effect to a maximum extent possible, the mass of the mass member and the spring constants of the two elastic support members are tuned up so as to maximally coincide the natural vibration frequency of the dynamic damper with the resonance frequency of the rotary shaft where the damper is to be mounted. It is most preferable that the damper is mounted on the rotary shaft while an axially center portion of the mass member, which is a center of gravity thereof, is coincided with the position of the loop of the bending vibration on the rotary shaft.

A dynamic damper is, however, mounted on a rotary shaft according to needs. Therefore, various members are arranged around the rotary shaft when the dynamic damper is mounted. Accordingly, even if the dynamic damper is attempted to be mounted on the rotary shaft so as to coincide the axially center portion of the mass member as the center of gravity thereof with the position of the bending vibration loop on the rotary shaft, the dynamic damper may contact or interfere with the other members arranged around the rotary shaft. In consequence, there may be caused a problem of obstruction in mounting the damper on the above-described desired position. In that case, it is inevitable to mount the dynamic damper on the rotary shaft in such a manner that the axially center portion of the mass member as the center of gravity thereof is positioned axially apart from the position of the bending vibration loop on the rotary shaft.

When the dynamic damper is mounted at the position axially apart from the position of the bending vibration loop on the rotary shaft as described above, the vibration damping characteristic is inevitably deteriorated. Thus, conventionally, in order to increase the damping effect (the vibration damping characteristic of the dynamic damper), methods for increasing the mass of the mass member have generally been discussed. However, such methods increase not only the mass (weight) of the entire dynamic damper but also the mass (weight) of the rotary shaft equipped with the dynamic damper. In addition, the size of the mass member become bigger, thereby a manufacturing cost of the dynamic damper is increased by the amount of increased mass thereof. Furthermore, other problems are arisen such as a need for a larger space to mount the dynamic damper.

### SUMMARY OF THE INVENTION

The present invention was made in the light of the above-described situation. It is therefore an object of the present invention to provide a structure for mounting a dynamic damper on a rotary shaft. In the mounting structure, a sufficient vibration damping effect can be obtained without unnecessarily increasing a mass of the mass member, even though the dynamic damper is mounted on the rotary shaft in such a manner that an axially center portion of a mass member is positioned axially apart from the position of a loop of bending vibration on the rotary shaft. It is another object of the invention to provide a rotary shaft equipped with a dynamic damper, in which the dynamic damper is mounted on the rotary shaft by employing the above mounting structure.

The above object may be attained according to a first aspect of the present invention, which provides a structure for mounting a dynamic damper on a rotary shaft, the dynamic damper comprising (i) a mass member with a cylindrical shape mounted on the rotary shaft where vibration is occurred, and (ii) a first and second elastic support members respectively formed on axially opposite end portions of the mass member with a predetermined axial distance therebetween to elastically support the mass member and allow the mass member to be relatively displaced while the mass member is mounted on the rotary shaft, the dynamic damper being mounted on the rotary shaft, such that an axial center of the mass member is spaced axially apart from a position of a loop of the bending vibration on the rotary shaft, wherein the mass member has a center of gravity at a position deviated from the axial center thereof toward a first end of axially opposite ends, and wherein the first and second elastic support members are fixed to the rotary shaft, upon the mass member being mounted on the rotary shaft such that an axial first section having the center of gravity of the mass member is located closer to the position of the loop of the bending vibration on the rotary shaft than an axial second section, whereby the dynamic damper is mounted on the rotary shaft.

In the mounting structure thereof according to a preferred form of the first aspect of the present invention, the first elastic support member has a larger spring constant than a spring constant of the second elastic support member, the first elastic support member fixed to the axial end portion of the first section having the center of gravity of the mass member and the second elastic support member fixed to the axial end portion of the second section of the mass member.

In the mounting structure thereof according to another preferred form of the first aspect of the present invention, a ratio between the spring constant of the first elastic support member and a mass supported by the first elastic support member is equal to a ratio between the spring constant of the second elastic support member and a mass supported by the second elastic support member.

In the mounting structure thereof according to another preferred form of the first aspect of the present invention, the mass member is made of a material having a single density, and a volume of the axial first section is made larger than a volume of the axial second section, whereby the mass member has the center of gravity at a position deviated from the axial center thereof toward a first end of axially opposite ends.

The above-indicated another object of the present invention may be attained cording to a second aspect of the present invention, which provides a rotary shaft equipped with a dynamic damper, the dynamic damper comprising (i) a mass member with a cylindrical shape mounted on the rotary shaft where vibration is occurred, and (ii) a first and second elastic support members respectively formed on axially opposite end portions of the mass member with a predetermined axial distance therebetween to elastically support the mass member and allow the mass member to be relatively displaced while the mass member is mounted on the rotary shaft, the dynamic damper being mounted on the rotary shaft, such that an axial center of the mass member is spaced axially apart from a position of a loop of the bending vibration on the rotary shaft, wherein the mass member has a center of gravity at a position deviated from the axial center thereof toward a first end of axially opposite ends, and, wherein the first and second elastic support members are fixed to the rotary shaft, upon the mass member being mounted on the rotary shaft such that an axial first section having the center of gravity of the mass member is located closer to the position of the loop of the bending vibration on the rotary shaft than an axial second section, whereby the dynamic damper is mounted on the rotary shaft.

According to a third aspect of the invention, there is provided a method for advantageously mounting a dynamic damper on a rotary shaft, comprising the step of preparing the rotary shaft where bending vibration is occurred and the dynamic damper including (i) a mass member with a cylindrical shape and (ii) a first and second elastic support members respectively formed on axially opposite end portions of the mass member with a predetermined axial distance therebetween to elastically support the mass member and allow the mass member to be relatively displaced while the mass member is mounted on the rotation shaft; mounting the dynamic damper on the rotary shaft, such that an axial center of the mass member is spaced axially apart from a position of a loop of the bending vibration on the rotary shaft, the mass member having a center of gravity at a position deviated from the axial center thereof toward a first end of axially opposite ends; and fixing the first and second elastic support members to the rotary shaft, upon the mass member being mounted on the rotary shaft such that the axial first section having the center of gravity of the mass member is located closer to the position of the loop of the bending vibration on the rotary shaft than an axial second section, whereby the dynamic damper is mounted on the rotary shaft.

In the structure for mounting a dynamic damper on a rotary shaft according to the first aspect of the present invention, although the axially center portion of the mass member is positioned axially apart from the position of the loop of the bending vibration on the rotary shaft, the dynamic damper is mounted on the rotary shaft in the state where the center of gravity of the mass member is either coincided with or maximally close to the position of the loop of the bending vibration thereon. This arrangement can advantageously provide the same or similar vibration damping effect as that obtained when the dynamic damper is mounted on the rotary shaft such that the axially center portion as the center of gravity of the mass member coincides with the position of the bending vibration loop thereon.

The structure for mounting a dynamic damper on a rotary shaft according to the first aspect of the present invention allows the dynamic damper to be mounted on the rotary shaft with a sufficient vibration damping effect stably secured, even when the axially center portion of the mass member is positioned axially apart from the position of the bending vibration loop on the rotary shaft, without increasing the mass of the mass member beyond necessity. As a result, the mounting structure can advantageously solve all various problems that have conventionally been caused, when mounting the dynamic damper on the rotary shaft as described above, by increasing the mass of the mass member to improve the vibration damping effect.

In the rotary shaft equipped with a dynamic damper according to the second aspect of the present invention, the dynamic damper is allowed to be mounted on the rotary shaft such that the center of gravity of the mass member is either coincided with or maximally close to the position of the bending vibration loop thereon even when the axially center portion of the mass member is positioned axially apart from the position of the bending vibration loop on the rotary shaft.

In addition, in the rotary shaft equipped with a dynamic damper according to the second aspect of the present invention described above, practically the same function and effect can advantageously be obtained as those obtained in the mounting structure thereof according to the first aspect of the invention described above.

Furthermore, in the mounting method according to the third aspect of the present invention, when the dynamic damper is mounted on the rotary shaft such that the axially center portion of the mass member is positioned axially apart from the position of the bending vibration loop on the rotary shaft, the damper can be mounted thereon in the state where the center of gravity of the mass member is either coincided with or maximally close to the position of the bending vibration loop thereon.

Accordingly, the above method can also advantageously provide practically the same function and effect as those in the mounting structure of the dynamic damper on the rotary shaft according to the first aspect of the invention described above.

### BRIEF DESCRIPTION OF THE DRAWINGS

The above and other objects, features, advantages and technical and industrial significance of the present invention will be better understood by reading the following detailed description of presently preferred embodiments of the invention, when considered in connection with the accompanying drawings, in which:

FIG. 1 is a front elevational view showing an embodiment of a rotary shaft equipped with a dynamic damper having a structure according to a first embodiment of the present invention;

FIG. 2 is an elevational view in axial cross section of the dynamic damper mounted on the rotary shaft shown in FIG. 1;

FIG. 3 is a partially enlarged view of FIG. 1;

FIG. 4 is a view corresponding to FIG. 1 showing an another embodiment of a rotary shaft equipped with a dynamic damper having a structure according to a second embodiment of the present invention; and

FIG. 5 is a partially enlarged view of FIG. 4.

### DETAILED DESCRIPTION OF THE PREFERRED EMBODIMENTS

To further clarify the present invention, there will be described in detail embodiments of the invention with reference to the accompanying drawings.

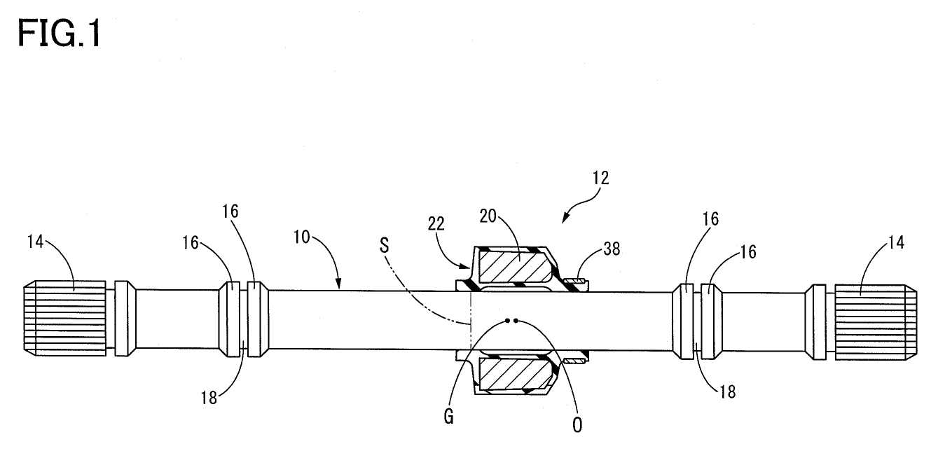

Referring first to FIG. 1, there is shown a front view showing a drive shaft equipped with a dynamic damper for an automobile as an embodiment of the rotary shaft with a dynamic damper mounted thereon according to a mounting structure of the present invention. In FIG. 1, only a dynamic damper 12 is shown in longitudinal cross section.

As apparent from FIG. 1, a drive shaft 10 is a generally long rod member which is hollow or solid and has a circular shape in transverse cross section. The drive shaft 10 integrally includes splined connecting portions 14, 14 having a large diameter at axially opposite ends thereof and two pairs of engaging portions 16, 16 each pair of which is formed axially inwardly of the respective connecting portions 14, 14 by a predetermined distance. Each pair of the engaging portions 16, 16 has a groove 18 therebetween.

In the drive shaft 10, there are attached universal joints (not shown) to the respective splined connecting portions 14, 14. One of the connecting portion 14, 14 is linked to an output shaft of a final speed reduction gear of a motor vehicle, while the other is linked to the driving wheel of the motor vehicle, via the respective universal joints. The connecting portions 14, 14 are covered by protecting covers and one of the opposite ends of each protecting cover is engaged with the groove 18 of the corresponding pair of engaging portions 16, 16.

The dynamic damper 12 is installed on a substantially axially middle portion of the above-constructed drive shaft 10. The dynamic damper 12 as a whole has generally cylindrical shape and is mounted on the drive shaft 10 so as to reduce bending vibration of the drive shaft 10 through a dynamic vibration absorbing system (damping system).

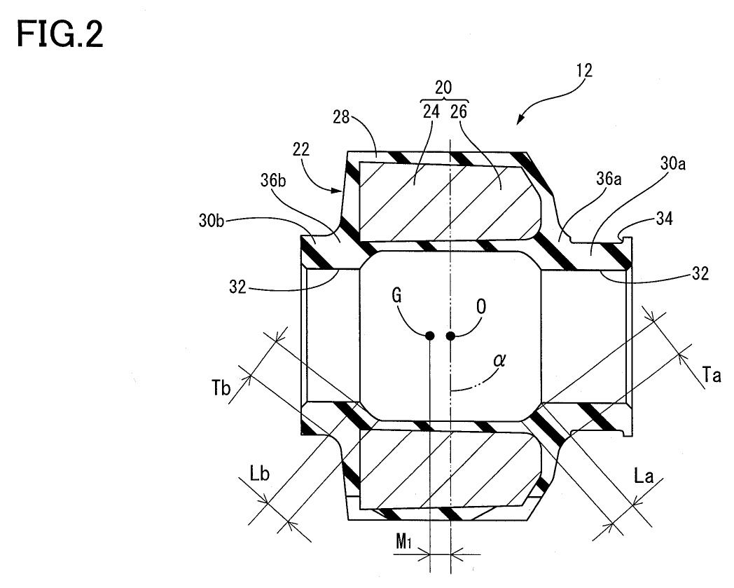

More specifically, as shown in FIGS. 1 and 2, the dynamic damper 12 includes a mass member 20 and a support rubber 22. The mass member 20 is made of a single kind of metallic material having a relatively large mass and a single density, and as a whole, has a thick substantially cylindrical shape with an inner diameter larger by a predetermined amount than an outer diameter of the drive shaft 10.

In the present embodiment, particularly, an inner circumferential surface of the mass member 20 is formed as a tapered surface with a diameter gradually increasing from an axially first end thereof (from the left side in FIG. 2) to an axially second end thereof (to the right side in FIG. 2), whereas an outer circumferential surface of the mass member 20 is formed as a tapered surface reverse to the inner circumferential surface thereof with a diameter gradually decreasing from the axially first end thereof to the axially second end thereof. In addition, the reversely tapered surface forming the outer circumferential surface of the mass member 20 has a taper angle slightly larger than a taper angle of the tapered surface forming the inner circumferential surface thereof. In other words, the mass member 20 has a cylindrical shape which has a circular shape in transverse cross section and has a partially varying thickness in which an outer diameter of an edge of the axially first end is the largest and an inner diameter of the edge thereof is the smallest, whereas an outer diameter of an edge of the axially second end is the smallest and an inner diameter of the edge thereof is the largest and the thickness of the mass member 20 is gradually reduced from the axially first edge toward the axially second edge. Hereinafter, for illustrative convenience, a region toward the axially first end of the mass member 20 having the larger thickness is referred to as the left side or the left, whereas a region toward the axially second end thereof having the smaller thickness is referred to as the right side or the right.

In the mass member 20, both inner and outer corners of the left end portion having larger thickness are made to have angular shape, respectively, whereas an inner corner of the right end portion having smaller thickness is made to have a protrudingly curved surface and an outer corner thereof is made to have an inclined surface like one formed by chamfering.

Accordingly, in the present embodiment, the mass member 20 having the single density is entirely formed into an irregular shape, which is asymmetrical to a virtual plane α including an axially center O. In the mass member 20, a left portion 24 made of a left half from the virtual plane α including the axially center O has a volume larger than that of a right portion 26 made of a right half therefrom, whereby the left portion 24 of the mass member 20 has a mass larger than that of the right portion 26 thereof. This allows a center of gravity G of the mass member 20 to be located at a position deviated axially from the axially center O to the left side by an amount indicated by M₁ in FIG. 2, that is, at the left portion 24. The amount M₁ of the deviation of the center of gravity G from the center O to the left side can be appropriately changed and adjusted according to a difference of the volume (mass) between the left portion 24 and the right portion 26 of the mass member 20.

Every portion of the support rubber 22 is formed of a rubber elastomer which is an appropriate single material, and the rubber support has a cylindrical shape as a whole. In the rubber support 22, an axially middle portion thereof is referred to as a covering rubber portion 28 having a small thickness, which covers the entire surface of the mass member 20 including the inner and outer circumferential surfaces and axially opposite end faces thereof. The covering rubber portion 28 has a substantially cylindrical shape with an inner diameter larger by a predetermined amount than the outer diameter of the drive shaft 10. The mass member 20 is entirely buried and covered in the covering rubber portion 28. The mass member 20 is adhered to the covering rubber portion 28 by vulcanization.

The axially opposite ends of the support rubber 22 are formed as fixing rubber portions 30a, 30b for fixing the mass member 20 covered by the covering rubber portion 28 to the drive shaft 10. Each of the fixing rubber portions 30a, 30b has a substantially thick cylindrical shape with an inner diameter smaller by a predetermined amount than that of the covering rubber portion 28 and also further smaller by a predetermined amount than the outer diameter of the drive shaft 10. Therefore, an inner circumferential surface of each of the fixing rubber portions 30a, 30b is referred to as a pressed surface 32, 32, as will be described below, that is pressed against an outer circumferential surface of the drive shaft 10 when the dynamic damper 12 is mounted on the drive shaft 10. Additionally, an inner diameter of the pressed surfaces 32, 32 as the inner circumferential surfaces of the fixing rubber portion 30a, 30b is made smaller than the inner diameter of the covering rubber portion 28, so that there is formed a stepped shape between the pressed surfaces 32, 32 and the inner circumferential surface of the covering rubber portion 28, which has the pressed surfaces 32, 32 inwardly.

The fixing rubber portions 30a, 30b are composed of a right fixing rubber portion 30a and a left fixing rubber portion 30b. The right fixing rubber portion 30a has an axial length longer by a predetermined amount than that of a left fixing rubber portion 30b and forms the right side end portion of the support rubber 20 and is arranged on the right side apart from the covering rubber portion 28. The left fixing rubber portion 30b forms the left side end portion of the support rubber 22 and is arranged on the left side apart from the covering rubber portion 28. On an outer circumferential surface of the right fixing rubber portion 30a, there is formed a belt groove 34 having a shallow and rectangular recess on which a fastening belt, which will be described below, is to be fitted and wound.

In the support rubber 22, a right side connecting rubber portion 36a is arranged between a right end portion of the covering rubber portion 28 and the right fixing rubber portion 30a thereof, and a left connecting rubber portion 36b is arranged between a left end portion of the covering rubber portion 28 and the left fixing rubber portion 30b thereof. The two connecting rubber portions 36a, 36b connect the both right and left ends of the covering rubber portion 28 to each fixing rubber portion 30a, 30b.

Specifically, the right connecting rubber portion 36a has a thick, tapered cylindrical shape extending from an inner corner of the right end portion of the covering rubber portion 28 to a left end portion of the right side fixing rubber portion 30a in an inclined manner toward radially inwardly and is integrated with the inner corner of the right end portion of the covering rubber portion 28 and the left end portion of the right side fixing rubber portion 30a, respectively, at the axially opposite ends. Meanwhile, the left connecting rubber portion 36b has a thick, tapered cylindrical shape extending from an inner corner of the left end portion of the covering rubber portion 28 to a right end portion of the left side fixing rubber portion 30b in an inclined manner toward radially inwardly and is integrated with the inner corner of the left side end of the covering rubber portion 28 and the right end portion of the left side fixing rubber portion 30b, respectively, at the axially opposite ends.

In the structure described above, the right and left connecting rubber portions 36a, 36b are both formed of the single material. In addition to that, a thickness Ta of the right connecting rubber portion 36a is made equal to a thickness Tb of the left connecting rubber portion 36b, as well as a length La of the right connecting rubber portion 36a is made equal to a length Lb of the left side connecting rubber portion 36b. Consequently, as spring components of the dynamic damper 12, a radial (an axially perpendicular direction) spring constant (shear spring constant) Ka of the right side connecting rubber portion 36a is made equal to a radial (the axially perpendicular direction) spring constant (shear spring constant) Kb of the left connecting rubber portion 36b.

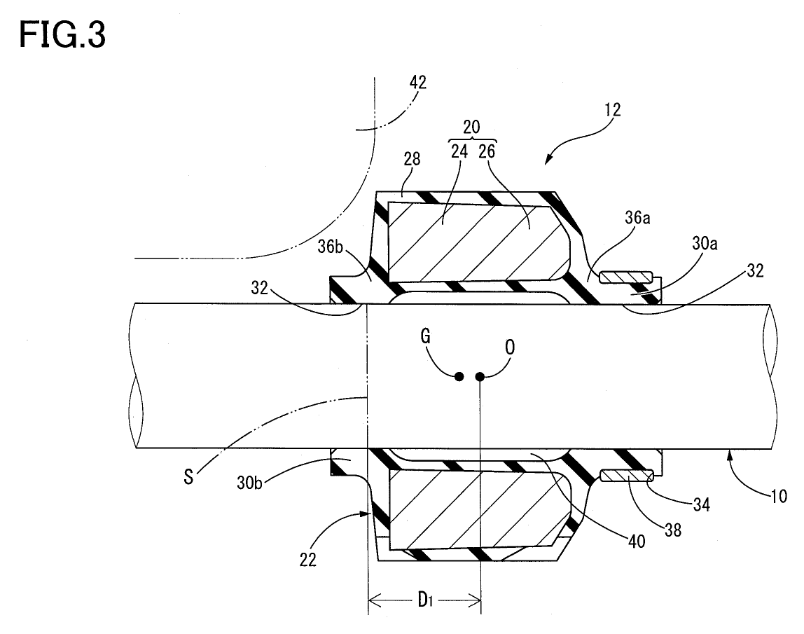

As shown in FIGS. 1 and 3, the dynamic damper 12 structured as above, is mounted on the axially middle portion of the drive shaft 10. The inner diameters of the right and left fixing rubber portions 30a, 30b of the support rubber 22 are made smaller than the outer diameter of the drive shaft 10 as described above. Therefore, upon the dynamic damper 12 being mounted on the drive shaft 10, the drive shaft 10 is press fitted into an inner hole of the support rubber 22 of the dynamic damper 12, whereby the pressed surface 32, 32 provided by the inner circumferential surface of each fixing rubber portion 30a, 30b of the support rubber 22 is brought into abutting contact with the outer circumferential surface of the drive shaft 10. Then, under that situation, a predetermined fastening belt 38 is fitted into the belt groove 34 of the right side fixing rubber portion 30a so as to be wound and fasten around the right side fixing rubber portion 30a. As a result, the dynamic damper 12 is securely and fixedly mounted on the drive shaft 10, thereby the drive shaft equipped with the dynamic damper is obtained.

In the present embodiment, the inner diameter of the covering rubber portion 28 of the support rubber 22 is made larger than the outer diameter of the drive shaft 10. Thus, upon the dynamic damper 12 being mounted on the drive shaft 10, an annular void 40 is formed between the inner circumferential surface of the covering rubber portion 28 and the outer circumferential surface of the drive shaft 10, thereby the mass member 20 covered by the covering rubber portion 28 is allowed to be radially displaced relative to the drive shaft 10.

Under installation of the drive shaft equipped with the dynamic damper in an automobile, when bending vibration (radial vibration) occurs in the drive shaft 10, the mass member 20 is radially displaced by the vibration and the right and left connecting rubber portions 36a, 36b are each mainly subjected to shear-deformation. In other words, in this case, the mass member 20 is elastically supported and allowed to be displaced relative to the drive shaft 10 by each of the connecting rubber portions 36a, 36b and each of the fixing rubber portions 30a, 30b, which are included in the support rubber 22. Thereby, the dynamic damper is formed to exhibit a damping effect or vibration suppressing effect against bending vibration on the drive shaft 10. As apparent from the structure described above, in the present embodiment, there are two elastic support members, one is composed of the right side connecting rubber portion 36a and the right side fixing rubber portion 30a of the support rubber 22 and the other is composed of the left connecting rubber portion 36b and the left side fixing rubber portion 30b thereof.

As shown in FIG. 3, in the present embodiment, under installation of the drive shaft equipped with the dynamic damper in an automobile, an obstacle 42 (indicated by a two-dotted chain line in FIG. 3) is located immediately above a position S of a loop or an antinode on the drive shaft 10. Thereby, the dynamic damper 12 is mounted at a position axially apart from the position S of the loop on the drive shaft 10. Specifically, the dynamic damper 12 is mounted on the drive shaft 10 in a state in which the axially center portion O of the mass member 20 is positioned apart from the position S of the loop on the drive shaft 10 by a predetermined distance D₁ so as not to come into contact with the obstacle 42. Particularly, the left portion 24 having the center of gravity G of the mass member 20 is mounted closer to the position S of the loop on the drive shaft 10 than the right portion 26.

Thus, in the present embodiment, for example, as compared to a case in which the dynamic damper including the mass member which is formed such that the axially center portion O thereof is coincided with the center of gravity G is mounted on the drive shaft 10 in the state in which the axially center portion O of the mass member is apart from the position S of the loop on the drive shaft 10 to the right side by the predetermined distance D₁, the center of gravity G of the mass member 20 is located at a position closer to the position S of the loop on the drive shaft 10 by an amount equivalent to the amount M₁ of the deviation of the center of gravity G from the axially center portion O to the left side. Thereby, the arrangement can advantageously provide a vibration damping effect similar to when the dynamic damper 12 is mounted on the drive shaft 10 in such a manner that the center of gravity G of the mass member 20 coincides with the position S of the loop on the drive shaft 10.

Accordingly, in the present embodiment, although the dynamic damper 12 is mounted on the drive shaft 10 in the state where the axially center portion O of the mass member 20 is located apart from the position S of the loop of the drive shaft 10 to the right side, a sufficient vibration damping effect can be stably obtained without unnecessarily increasing the mass of the mass member 20. As a result, the present embodiment can collectively and effectively solve various problems caused by an increase in the mass of the mass member 12, such as increases in the weight of the dynamic damper 12 and the drive shaft 10 equipped with the dynamic damper 12, an increase in a manufacturing cost due to upsizing of the mass member 12, and a need for a space to arrange the dynamic damper 12 when the drive shaft with the dynamic damper is installed in an automobile.

Additionally, in the present embodiment, the mass member 20 is made of the metallic material having the single density, and the left side portion 24 has the volume larger than that of the right portion 26 so as to make the mass of the left side portion 24 larger than that of the right side portion 26, whereby the center of gravity G of the mass member 20 is located on the left side portion 24. Accordingly, the position of the center of gravity G can be located at any position in the relatively simple and low-cost structure.

In the present embodiment, as described above, the radial spring constant Ka of the right side connecting rubber portion 36a is made equal to the radial spring constant Kb of the left side connecting rubber portion 36b. Thus, although the mass of the left side portion 24 of the mass member 20 is made different from the mass of the right side portion 26 thereof, it can be advantageously prevented that the structure of the support rubber 22, and consequently, the entire structure of the dynamic damper 12 from becoming complicated.

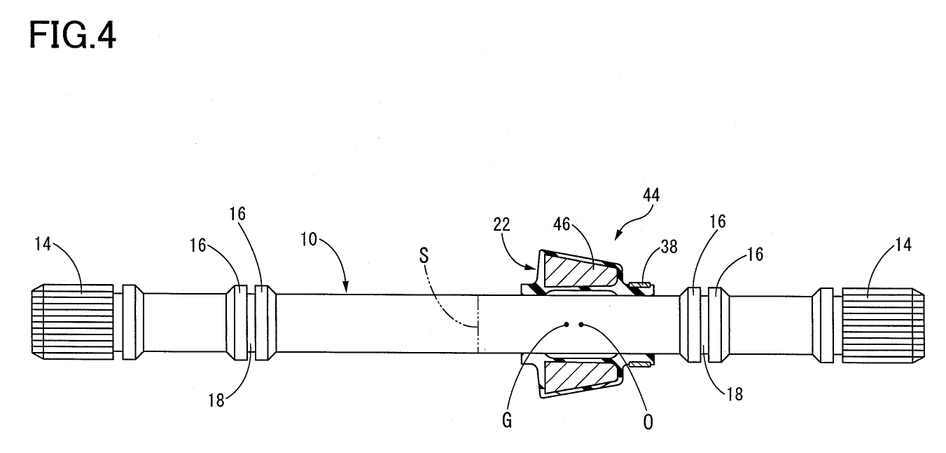

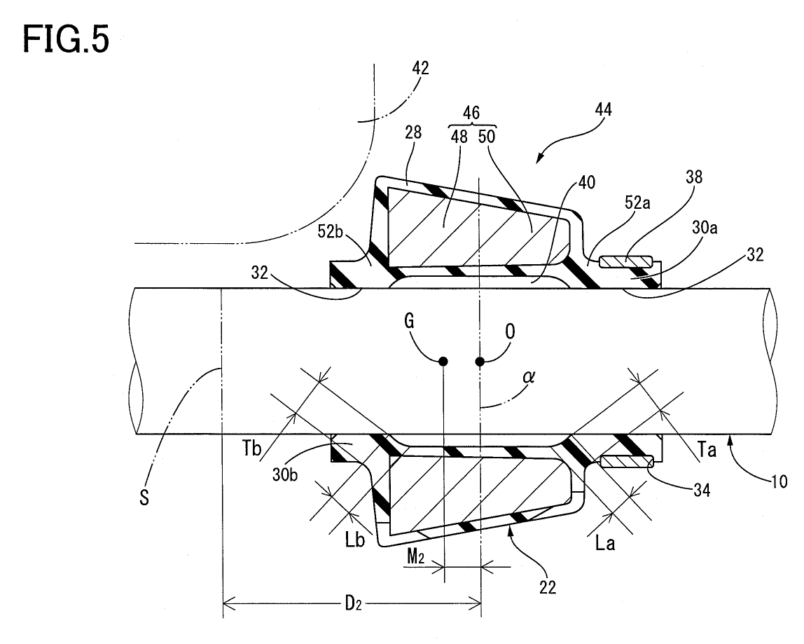

FIGS. 4 and 5 show a structure of a dynamic damper according to a second embodiment of the present invention, which is different from the structure according to the first embodiment shown in FIGS. 1 to 3. In the embodiment shown in FIGS. 4 and 5, the same reference numerals are given to members and portions formed in the same manner as in the first embodiment in FIGS. 1 to 3 and thus description thereof will be omitted.

In the present embodiment, a mass member 46 of a dynamic damper 44 has a basic structure similar to that of the mass member 20 of the dynamic damper 12 in the first embodiment. However, a difference between a mass of a left side portion 48 of the mass member 46 and a mass of a right side portion 50 thereof is made sufficiently larger than a difference between the mass of the left side portion 24 of the mass member 20 and the mass of the right side portion 26 thereof in the first embodiment.

Specifically, an inner circumferential surface of the mass member 46 having a single density has a tapered surface with a diameter gradually increasing from an axially first end (the left in FIG. 5, which will be referred to as the left side) to an axially second end (the right in FIG. 5, which will be referred to as the right side), whereas an outer circumferential surface thereof has a tapered surface reverse to that of the inner circumferential surface. A difference between a tapered angle of the reversely tapered surface forming the outer circumferential surface and a tapered angle of the tapered surface forming the inner circumferential surface is made sufficiently larger than a difference between the tapered angles of the tapered surfaces forming the inner and outer circumferential surfaces of the mass member 20 in the first embodiment. Thereby, the mass member 46 has a cylindrical shape which has a circular shape in transverse cross section and a thickness of the mass member is gradually reduced from a left edge toward a right edge. Additionally, a reduction amount of the thickness of the mass member 46 reducing from the left edge toward the right edge is made much larger than that of the thickness of the mass member 20 in the first embodiment. Then, in the mass member 46, the left side portion 48 made of a left half from the virtual plane α including the axially center portion O thereof has a mass sufficiently larger than that of the right portion 50 made of a right half therefrom.

Accordingly, the center of gravity G of the mass member 46 is located at a position axially deviated from the axially center portion O to the left side by an amount indicated by M₂ shown in FIG. 5, that is, the center of gravity G is located on the left side portion 48. An amount M₂ of deviation of the center of the gravity G from the axially center portion O to the left side is made larger by a predetermined amount than the amount M₁ of the deviation thereof from the axially center portion O to the left side in the mass member 20 of the first embodiment.

The dynamic damper 44 with the mass member 46 structured as above is mounted on the drive shaft 10 in the same manner as in the first embodiment. Thereby, a mass Wb of the mass member 46 supported by a left side connecting rubber portion 52b and a left side fixing rubber portion 30b in the support rubber 22 is made sufficiently larger than a mass Wa of the mass member 46 supported by a right side connecting rubber portion 52a and the right fixing rubber portion 30a.

Furthermore, in this case, the right side connecting rubber portion 52a and the left side connecting rubber portion 52b supporting the mass member 46 are made of a single material. The length La of the right side connecting rubber portion 52a is equal to the length Lb of the left side connecting rubber portion 52b, whereas the thickness Tb of the left side connecting rubber portion 52b is made larger by a predetermined amount than the thickness Ta of the right side connecting rubber portion 52a. Thereby, as a spring component of the dynamic damper 44, the radial (axially perpendicular direction) spring constant (shear spring constant) Kb of the left side connecting rubber portion 52b is made larger than the radial (axially perpendicular direction) spring constant (shear spring constant) Ka of the right connecting rubber portion 52a. In other words, the radial spring constant Kb of the left connecting rubber portion 52b having a low input vibration frequency due to the larger supported mass Wb of the mass member 46 is made larger than the radial spring constant Ka of the right connecting rubber portion 52a having a high input vibration frequency due to the smaller supported mass Wa of the mass member 46.

Particularly, in the present embodiment, the spring constant Kb of the left side connecting rubber portion 52b and the spring constant Ka of the right side connecting rubber portion 52a are set such that a ratio Kb/Wb between the spring constant Kb of the left connecting rubber portion 52b and the supported mass Wb of the mass member 46 supported by the left side connecting rubber portion 52b and the left side fixing rubber portion 30b is equal to a ratio Ka/Wa between the spring constant Ka of the right side connecting rubber portion 52a and the supported mass Wa of the mass member 46 supported by the right connecting rubber portion 52a and the right fixing rubber portion 30a. In this manner, the dynamic damper 44 is formed so as to have a single natural vibration frequency. Additionally, in the present embodiment, the dynamic damper 44 is tuned up so as to effectively damp the vibration of high frequency and minute amplitude.

Under installation of the drive shaft equipped with the dynamic damper in an automobile, the dynamic damper 44 formed as above is similarly mounted on the drive shaft 10 such that the axially center portion O of the mass member 46 is apart from the position S of the loop on the drive shaft 10 to the right side by a predetermined distance D₂ so as not to come into contact with the obstacle 42. Particularly, also in this case, the left side portion 48 having the center of gravity G of the mass member 46 is mounted closer to the position S of the loop thereof than the right side portion 50. In addition, the distance D₂ between the axially center portion O of the mass member 46 and the position S of the loop on the drive shaft 10 is made larger by a predetermined amount than the distance D₁ between the axially center portion O of the mass member 20 and the position S of the loop on the drive shaft 10 in the first embodiment.

In this manner, in the present embodiment, for example, as compared to the case in which the dynamic damper with the mass member formed such that the axially center portion O is coincided with the center of gravity G is mounted on the drive shaft 10 in the state where the axially center portion O of the mass member is apart from the position S of the loop on the drive shaft 10 to the right side by the predetermined distance D₂, the center of gravity G of the mass member 46 is located closer to the position S of the loop of the drive shaft 10 by an amount equivalent to the amount M₂ of deviation of the center of gravity G from the axially center portion O to the left side. Thereby, the arrangement can advantageously provide a vibration damping characteristic similar to that obtained when the dynamic damper 44 is mounted on the drive shaft 10 such that the center of gravity G of the mass member 46 coincides with the position S of the loop of the drive shaft 10.

Therefore, also in the present embodiment described above, substantially the same excellent function and effect can advantageously be obtained as those in the first embodiment.

In addition, in the present embodiment described above, particularly, the radial spring constant Kb of the left side connecting rubber portion 52b, which is the spring components of the dynamic damper 44, is made larger than the radial spring constant Ka of the right side connecting rubber portion 52a. Accordingly, upon the dynamic damper 44 being mounted on the drive shaft 10, although the mass Wb of the mass member 46 supported by the left side connecting rubber portion 52b is made sufficiently larger than the mass Wa supported by the right side connecting rubber portion 52a, the present embodiment can advantageously prevent a phenomenon, when bending vibration occurs in the drive shaft 10, in which the amount of displacement by vibration at the left end of the left portion 48 having the larger mass becomes larger than the amount of displacement by vibration at the right end of the right portion 50 having the smaller mass. Consequently, a desired vibration damping effect can be obtained in a sufficiently stable manner.

Additionally, in the present embodiment, the dynamic damper 44 is formed so as to have the single natural vibration frequency. Therefore, for example, it can prevent a deterioration in the damping characteristic of the dynamic damper 44 caused by that the dynamic damper 44 has a plurality of natural vibration frequencies. Thus, an excellent vibration damping effect can be obtained.

Hereinabove, as apparent from the foregoing two embodiments, in the present invention, in a comparison between the case in which the distance D between the axially center portion O of the mass member 20 (46) and the position S of the loop on the drive shaft 10 is smaller and the case in which the distance therebetween is larger, in the former case, preferably, the amount M of deviation of the center of the gravity G of the mass members 20 (46) from the axially center portion O toward the axially first end (the left side in the two embodiments) is made small and the radial spring constants Ka and Kb of the two connecting rubber portions 36a (52a) and 36b (52b) of the support rubber 22 are made equal to each other. Meanwhile, in the latter case, preferably, the amount M of deviation of the center of gravity thereof from the axially center portion O toward the axially first end (the left side therein) is made large. In addition to that, in the two connecting rubber portions 36a (52a) and 36b (52b) of the support rubber 22, preferably, the radial spring constant Kb of the connecting rubber portion 36b (52b) fixed to the end portion (the left end in the two embodiments) of the side having the center of gravity G of the mass member 20 (46) is made larger than the radial spring constant Ka of the connecting rubber portion 36a (52a) fixed to the end portion (the right side end portion in the two embodiments) of the side opposite thereto.

While the present invention has been described in detail for the illustrative purpose only, it is to be understood that the invention is not limited to the details of the illustrated embodiments.

For example, in the illustrated two embodiments, the dynamic damper 12 (44) is mounted on the drive shaft 10 at the position where the axially center portion O of each mass member 20 (46) is apart from the position S of the loop on the drive shaft 10 to the right side by the predetermined distance in such a manner that the left side portion 24 (48) having the center of gravity G of the mass member 20 (46) is closer to the position S of the loop thereof than the right side portion 26 (50), that is, in such a manner that the left side portion 24 (48) is located on the left side more than the right side portion 26 (50). However, even if the dynamic damper 12 (44) is mounted on the drive shaft 10 at the position where the axially center portion O of the mass member 20 (46) is apart from the position S of the loop on the drive shaft 10 to the left side by a predetermined distance, the damper is mounted thereon in such a manner that the left portion 24 (48) having the center of gravity G of the mass member 20 (46) is closer to the position S of the loop on the drive shaft 10 than the right portion 26 (50), that is, in such a manner that the left portion 24 (48) is located on the right side more than the right side portion 26 (50).

Additionally, in the first embodiment, since the distance D₁ between the axially center portion O of the mass member 20 and the position S of the loop on the drive shaft 10 is small, the radial spring constants Ka and Kb of the two connecting rubber portions 36a, 36b of the support rubber 22 are made equal to each other. However, even when the distance D₁ therebetween is small, the radial spring constant Kb of the connecting rubber portion 36b fixed to the end portion (the left end in the first embodiment) of the side having the center of gravity G of the mass member 20 can be made larger than the radial spring constant Ka of the connecting rubber portion 36a fixed to the opposite end portion (the right end portion in the first embodiment). In this manner, it is possible to effectively prevent the occurrence of an imbalanced vibration displacement between the both right and left end portions caused by the difference of mass between the left side and right side portions 24, 26 of the mass member 20.

Furthermore, regarding the structure for setting the center of gravity G of the mass member 20 (46) at the position deviated from the axially center portion O toward the axially first end, it is not limited to the exemplified structure.

For example, the left side portion 24 (48) and the right side portion 26 (50) of the mass member 20 (46) may be made of materials having different densities, whereby one of the left and right portions having a larger density may have the center of gravity G. In this structure, the entire shape of the mass member 20 (46) can be made symmetrical to the plane a including the axially center portion O. As a result, for example, unlike a case in which one of the left side portion 24 (48) and the right side portion 26 (50) is formed to have a volume larger than that of the other so as to position the center of gravity G on the portion having the larger volume, there can be obtained an advantage in which only respectively small space is required for the installation of the mass member 20 (46), and consequently, the dynamic damper 12 (44) can be made relatively small.

The shapes of the right and left portions 24 (48) and 26 (50) of the mass member and the entire shape of the mass member 20 (46) are not particularly limited to those illustrated embodiments even when there is employed the structure in which the left side and right side portions 24 (48) and 26 (50) of the mass member 20 (46) are made of the material having the single density and then the volumes of those portions are made different from each other to deviate the position of the center of gravity G.

Furthermore, the structure for fixing the support rubber 22 of the dynamic damper 12 at the predetermined position of the drive shaft 10 is also not limited to the illustrated structure which employs the fastening belt. Any one of known structures for fixing the member to the drive shaft can be appropriately employed.

In addition, the present invention is advantageously applicable to the both cases in which the bending vibration occurring in the rotary shaft (drive shaft 10) is either a first mode or multiple vibration modes. Even in the case in which the bending vibration is the multiple vibration mode, one of dynamic dampers whose center of gravity is located at a position deviated from the axially center portion toward the axially first end may be mounted on the rotary shaft in a state in which the axially first end of a portion having the center of gravity is mounted closer to any one of a plurality of vibration loops positioned on the rotary shaft, for example.

In the above preferred embodiments of the present invention, there have been described the structure for mounting a dynamic damper on an automobile drive shaft and the automobile drive shaft equipped with the dynamic damper. However, the principle of the invention can advantageously be applied to any of structures for mounting a dynamic damper on a rotary shaft other than a drive shaft installed in an automobile or a rotary shaft installed in machinery other than an automobile, as well as a rotary shaft equipped with the dynamic damper having the mounting structure.

It is to be understood that the present invention may be embodied with various other changes and modifications which may occur to those skilled in the art, without departing from the spirit and scope of the invention.

What is claimed is:

1. A structure for mounting a dynamic damper on a rotary shaft, the dynamic damper comprising (i) a mass member with a cylindrical shape mounted on the rotary shaft where vibration is occurred, and (ii) a first and second elastic support members respectively formed on axially opposite end portions of the mass member with a predetermined axial distance therebetween to elastically support the mass member and allow the mass member to be relatively displaced while the mass member is mounted on the rotary shaft, the dynamic damper being mounted on the rotary shaft, such that an axial center of the mass member is spaced axially apart from a position of a loop of the bending vibration on the rotary shaft,
wherein the mass member has a center of gravity at a position deviated from the axial center thereof toward a first end of axially opposite ends, and
wherein the first and second elastic support members are fixed to the rotary shaft, upon the mass member being mounted on the rotary shaft such that an axial first section having the center of gravity of the mass member is located closer to the position of the loop of the bending vibration on the rotary shaft than an axial second section, whereby the dynamic damper is mounted on the rotary shaft.

2. The structure for mounting a dynamic damper on a rotary shaft according to claim 1, wherein the first elastic support member has a larger spring constant than a spring constant of the second elastic support member, the first elastic support member fixed to the axial end portion of the first section having the center of gravity of the mass member and the second elastic support member fixed to the axial end portion of the second section of the mass member.

3. The structure for mounting a dynamic damper on a rotary shaft according to claim 2, wherein a ratio between the spring constant of the first elastic support member and a mass supported by the first elastic support member is equal to a ratio between the spring constant of the second elastic support member and a mass supported by the second elastic support member.

4. The structure for mounting a dynamic damper on a rotary shaft according to claim 1, wherein the mass member is made of a material having a single density, and a volume of the axial first section is made larger than a volume of the axial second section, whereby the mass member has the center of gravity at a position deviated from the axial center thereof toward a first end of axially opposite ends.

5. The structure for mounting a dynamic damper on a rotary shaft according to claim 1, wherein the dynamic damper is an assembly integrally including the first and second elastic member and the mass member located therebetween.

6. The structure for mounting a dynamic damper on a rotary shaft according to claim 1, wherein at least one of an inner and outer circumferential surfaces of the mass member is formed to have a tapered surface.

7. A rotary shaft equipped with a dynamic damper, the dynamic damper comprising (i) a mass member with a cylindrical shape mounted on the rotary shaft where vibration is occurred, and (ii) a first and second elastic support members respectively formed on axially opposite end portions of the mass member with a predetermined axial distance therebetween to elastically support the mass member and allow the mass member to be relatively displaced while the mass member is mounted on the rotary shaft, the dynamic damper being mounted on the rotary shaft, such that an axial center of the mass member is spaced axially apart from a position of a loop of the bending vibration on the rotary shaft,
wherein the mass member has a center of gravity at a position deviated from the axial center thereof toward a first end of axially opposite ends, and
wherein the first and second elastic support members are fixed to the rotary shaft, upon the mass member being mounted on the rotary shaft such that an axial first section having the center of gravity of the mass member is located closer to the position of the loop of the bending vibration on the rotary shaft than an axial second section, whereby the dynamic damper is mounted on the rotary shaft.

8. A method for mounting a dynamic damper on a rotary shaft, comprising the step of:
preparing the rotary shaft where bending vibration is occurred and the dynamic damper including (i) a mass member with a cylindrical shape and (ii) a first and second elastic support members respectively formed on axially opposite end portions of the mass member with a predetermined axial distance therebetween to elastically support the mass member and allow the mass member to be relatively displaced while the mass member is mounted on the rotation shaft;
mounting the dynamic damper on the rotary shaft, such that an axial center of the mass member is spaced axially apart from a position of a loop of the bending vibration on the rotary shaft, the mass member having a center of gravity at a position deviated from the axial center thereof toward a first end of axially opposite ends; and
fixing the first and second elastic support members to the rotary shaft, upon the mass member being mounted on the rotary shaft such that the axial first section having the center of gravity of the mass member is located closer to the position of the loop of the bending vibration on the rotary shaft than an axial second section, whereby the dynamic damper is mounted on the rotary shaft.
